(19) United States
(12) Patent Application Publication
(10) Pub. No.: US 2026/0116342 A1
(43) Pub. Date: Apr. 30, 2026

(54) CONTROLLING VEHICLE ACCESS AND USAGE FUNCTIONALITY BASED ON USER AUTHENTICATION USING FACIAL RECOGNITION AND OTHER AUTHENTICATION METHODS

(71) Applicant: Volvo Car Corporation, Göteborg (SE)

(72) Inventors: Hossein Soleimani, Gothenburg (SE); Bhavesh Patel, Gothenburg (SE); Balaji Vadivel, Gothenburg (SE); Divya Ravikumar, Gothenburg (SE); Ping Gong, Gothenburg (SE)

(21) Appl. No.: 18/928,818

(22) Filed: Oct. 28, 2024

(51) Int. Cl. B60R 25/25; B60R 25/04; B60R 25/31; G06V 40/16

(52) U.S. Cl. CPC B60R 25/25; B60R 25/04; B60R 25/31; G06V 40/172

(57) ABSTRACT

Advanced keyless vehicle entry and usage control systems and methods are provided. For example, a method comprises performing, by a system onboard a vehicle and comprising a processor, an identification/verification process to identify and verify an identity of a person located within a defined distance relative to the vehicle based on biometric data (e.g., facial image data, voice data, and other biometric data) captured of the person, via one or more sensors located on or within the vehicle. The method further comprises determining, by the system, access authorization information regarding whether the person is authorized to access one or more internal compartments of the vehicle based on verification of the identity of the person, and controlling, by the system, access to the one or more internal compartments via electronically controlling unlocking and locking of an enclosure of the one or more internal compartments in accordance with the access authorization information.

### TECHNICAL FIELD

The disclosed subject matter relates to vehicles (e.g., transportation vehicles), and more particularly, to controlling vehicle access and usage functionality based on user authentication using facial recognition and other authentication methods.

### BACKGROUND

Keyless entry for vehicles is a modern system that allows a person to unlock, lock, and start their car without using a traditional physical key. Typically, the keyless entry system involves usage of a small device such as a key fob or keyless remote that communicates wirelessly with the car's onboard computer system. As the person approaches the vehicle, the car detects the presence of the key fob via proximity sensors. Once the system recognizes the key fob within a certain range, it authenticates the signal. This is usually done by transmitting a unique code between the fob and the car. The vehicle can be unlocked and locked using corresponding buttons on the key fob. Many keyless entry systems also include a push-button start feature. As long as the authenticated key fob is inside the car, any person can start the engine by pressing a button on the dashboard or console. Some newer systems may also include fingerprint scanners for authenticating users prior to unlocking the vehicle for added security.

Overall, keyless entry systems offer convenience and security, eliminating the need to fumble for keys while providing protection against theft. However, existing keyless entry systems for vehicles leave room for improvement.

In particular, existing keyless entry systems that do not incorporate fingerprint scanners still require the user to have the key fob to enter and start the vehicle. Thus, if the key fob is lost, misplaced, damaged and/or the battery powering the device dies or becomes weak, the vehicle cannot be accessed or started. In addition, key fob entry systems are vulnerable to hacking, allowing thieves to intercept and replicate the signal from the key fob. Environmental factors such as radio frequency interference can also disrupt the communication between the key fob and the vehicle, causing the keyless entry system to malfunction or fail. Further, key fob-based entry systems sometimes suffer from accidental activation, such as unlocking the vehicle when the key fob is in close proximity, leading to potential security risks if the owner is unaware.

While fingerprint scanners offer enhanced security compared to traditional keyless entry systems, they also come with their own set of challenges and considerations that need to be addressed to ensure reliable and secure operation. In particular, fingerprint scanners may not always be reliable, especially in extreme weather conditions or if the scanner becomes dirty or damaged. Factors like moisture, dirt, or even minor cuts or abrasions on the finger can affect the scanner's ability to accurately read fingerprints. On the flip side, there's also the risk of false acceptances, where the scanner mistakenly identifies an unauthorized fingerprint as valid, potentially compromising the security of the vehicle. In addition, implementing fingerprint scanners in vehicles adds complexity and cost to the manufacturing process. This could potentially increase the overall cost of the vehicle and make repairs or replacements more expensive.

Addressing these issues requires ongoing advancements in technology and security measures to enhance the reliability and safety of keyless entry systems for vehicles.

The above-described background relating to keyless entry for vehicle is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate controlling vehicle access and usage functionality based on user authentication using facial recognition and other authentication methods.

As alluded to above, techniques for enhancing the reliability and safety of keyless entry systems for vehicles are desirable, and various embodiments are described herein to this end and/or other ends.

According to an embodiment, a system can comprise one or more sensors integrated on or within a vehicle, a memory that stores computer executable components, and a processor that executes the computer executable components stored in the memory, including an identification/verification component, an authorization component, and a control component. The identification/verification component performs an entity identification/verification process to identify and verify an identity of a person located within a defined distance relative to the vehicle based on biometric data captured of the person via at least one sensor of the one or more sensors and reference identity verification data for one or more defined identities. The authorization component determines access authorization information regarding whether the person is authorized to access one or more internal compartments of the vehicle based on verification of the identity of the person in accordance with the entity identification/verification process and reference access authorization information defining access permissions for the one or more defined identities, and the control component that controls access to the one or more internal compartments via electronically controlling unlocking and locking of an enclosure of the one or more internal compartments in accordance with the access authorization information.

In various embodiments, the biometric data comprises facial image data of the person and wherein the identification/verification process comprises a facial recognition process. Additionally, or alternatively, the biometric data comprises a combination of two or more different types of data selected from the group consisting of: facial image data, body image data, voice data, fingerprint data, iris/retina data and gesture data, and wherein the entity identification/verification process comprises a defined sequence of two or more different identity verification checks.

In some embodiments, the authorization component further determines usage authorization information regarding whether and how the person is authorized to utilize one or more operating functionalities of the vehicle based on the verification of the identity of the person and reference usage authorization information defining usage permissions for the one or more defined identities, and wherein the control component controls usage of the one or more operating functionalities of the vehicle by the person in accordance with the usage authorization information. For example, the one or more operating functionalities can comprise a driving functionality, and wherein the control component controls activation and deactivation of the driving functionality in accordance with the usage authorization information.

According to another embodiment, a method can comprise performing, by a system onboard a vehicle and comprising a processor, an entity identification/verification process to identify and verify an identity of a person located within a defined distance relative to the vehicle based on biometric data captured of the person, via one or more sensors located on or within the vehicle, and reference identity verification data for one or more defined identities. The method further comprises determining, by the system, access authorization information regarding whether the person is authorized to access one or more internal compartments of the vehicle based on verification of the identity of the person in accordance with the entity identification/verification process and reference access authorization information defining access permissions for the one or more defined identities. The method further comprises controlling, by the system, access to the one or more internal compartments via electronically controlling unlocking and locking of an enclosure of the one or more internal compartments in accordance with the access authorization information.

According to yet another embodiment, a non-transitory machine-readable medium can comprise executable instructions that, when executed by a processor integrated on or within a vehicle, facilitate performance of operations, comprising, performing an entity identification/verification process to identify and verify an identity of a person located within a defined distance relative to the vehicle based on biometric data captured of the person, via one or more sensors located on or within the vehicle, and reference identity verification data for one or more defined identities. The operations further comprising, determining access authorization information regarding whether the person is authorized to access one or more internal compartments of the vehicle based on verification of the identity of the person in accordance with the entity identification/verification process and reference access authorization information defining access permissions for the one or more defined identities. The operations further comprising controlling access to the one or more internal compartments via electronically controlling unlocking and locking of an enclosure of the one or more internal compartments in accordance with the access authorization information.

### BRIEF DESCRIPTION OF DRAWINGS

FIG. 1 illustrates a block diagram of an exemplary system that facilitates controlling vehicle access and usage functionality based on user authentication using facial recognition and other authentication methods, in accordance with one or more embodiments described herein.

FIG. 2 illustrates an example implementation of a vehicle incorporating facial recognition-based entry in accordance with one or more embodiments described herein.

FIG. 3 illustrates a block diagram of example computer-executable components of an onboard computer system of a vehicle that facilitate controlling vehicle access and usage functionality, in accordance with one or more embodiments described herein.

FIG. 4 illustrates a block diagram of additional example computer-executable components of an onboard computer system of a vehicle that facilitate controlling vehicle access and usage functionality, in accordance with one or more embodiments described herein.

FIG. 5 illustrates a block flow diagram of an example, non-limiting computer-implemented method for controlling vehicle access, in accordance with one or more embodiments described herein.

FIG. 6 illustrates a block flow diagram of another example, non-limiting computer-implemented method for controlling vehicle access, in accordance with one or more embodiments described herein.

FIG. 7 illustrates a block flow diagram of an example, non-limiting computer-implemented method for controlling vehicle access and usage functionality, in accordance with one or more embodiments described herein.

FIG. 8 illustrates a block flow diagram of an example, non-limiting computer-implemented method for controlling vehicle access and usage functionality, in accordance with one or more embodiments described herein.

FIG. 9 is an example, non-limiting computing environment in which one or more embodiments described herein can be implemented.

FIG. 10 is an example, non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As alluded to above, techniques for improving keyless entry systems for vehicles are desirable, and various embodiments are described herein to this end and/or other ends. In accordance with one or more embodiments, the disclosed solution provides an advanced keyless entry system for vehicles that utilizes facial recognition and other authentication mechanisms to control access to the vehicle. The disclosed keyless entry system can also provide for controlling one or more usage functionalities of the vehicle based by the person authorized to access to the vehicle based on usage permissions authorized for the person.

For example, in one or more embodiments, in association with a person attempting to access a vehicle, such as in response to the person approaching the vehicle, being within a defined distance of the vehicle, engaging a door handle of the vehicle, or the like, an onboard computer system of the vehicle initiates an entity identification/verification and authorization process to determine if the person attempting to access the car is authorized to do so. In various embodiments, the entity identification/verification and authorization process can involve using facial recognition technology to determine and verify the identity of the person based on facial image data captured of the person via one or more cameras integrated on or within the vehicle. Additionally, or alternatively, the entity identification/verification process can involve identifying and verifying the identity of the person based on other biometric data captured of the person at the time of attempted access via one or more sensors integrated on or within the vehicle. For example, the other biometric data can include, but is not limited to, body image data, voice data, fingerprint data, iris/retina data and gesture data. In some embodiments, the entity identification/verification process can involve using a security application executed on external device (e.g., external to the vehicle) associated with the person attempting access, such as a smartphone, a smartwatch or the like, that communicates a digital key with the onboard vehicle computer system instructing the onboard vehicle computer system to open the vehicle following authentication of the person. In some implementations, the entity identification/verification process can employ a combination of two or more different entity verification checks to authenticate the identity of the person attempting to access the vehicle.

Once the person has been identified and verified, the onboard computer system of the vehicle can determine whether the person is authorized to access the vehicle and controls access accordingly via unlocking and locking respective enclosures of the vehicle. For example, the onboard computer system of the vehicle can store (e.g., in memory thereof) access authorization information linking defined user identities (e.g., usernames, unique identifiers, etc.) to access permissions. The access permissions can be tailored to one or more specific compartments or of the vehicle (e.g., the main cabin and the trunk for instance). For example, the access permissions may allow a first user identity to access all compartments of the vehicle and a second user identity to access only the trunk of the vehicle. The access permissions can also be tailored based on context (e.g., time of day, day of week, location, and other contextual parameters). For example, the access permissions may allow a first user identity to access all compartments of the vehicle under any contexts and a second user identity to access only the trunk of the vehicle over a defined time window.

In some embodiments, in addition to controlling access to the vehicle based on verifying that the person is authorized to do so, the onboard computer system of the vehicle can also control usage of one or more functionalities of the vehicle based on the identity of the person. For example, the onboard computer system of the vehicle can store (e.g., in memory thereof) usage authorization information linking defined user identities (e.g., biometric data, usernames, unique identifiers, etc.) to vehicle usage permissions. In this regard, the usage permissions can relate to one or more operating functionalities of the vehicle that the user is authorized (or not authorized) to utilize, such as the driving functionality of the vehicle, the heating/ventilation and cooling (HVAC) system of the vehicle, the infotainment system of the vehicle, and so on. For example, the usage permissions may allow one user to enter and employ the driving functionality of the vehicle and another user to only access the vehicle to retrieve something yet not use the driving functionalities of the vehicle. The onboard computer system of the vehicle can further automatically control activation and deactivation of the operating functionalities of the vehicle in accordance with the usage permissions. For example, the onboard computer system can automatically start the vehicle or enable the user to start the vehicle (e.g., via a push button located inside the vehicle or the like) based on the user having permission to start the vehicle.

In some implementations, the usage permissions can also be tailored based on context (e.g., time of day, day of week, location, and other contextual parameters). For example, the usage permissions can restrict usage of the driving functionality of the vehicle to a particular identity based on a particular context (e.g., time of day, day of week, location, route, speed, etc.). In some implementations, the usage permissions can also include or correspond to settings regarding preferences of the identity with respect to various features and functionalities of the vehicle and the onboard computer system can automatically configure the features and functionalities in accordance with the settings for a given usage scenario by an authorized identity. For example, the settings information can relate to settings of any onboard vehicle system or device that can be electronically controlled by the onboard computer system of the vehicle, such as seat position settings, HVAC settings, infotainment settings, navigation/route settings, and so on.

In some embodiments, the disclosed techniques can also incorporate artificial intelligence (AI) to facilitate inferring access permissions, usage permissions, and settings preferences for one or more people with respect to a vehicle based on historical access and usage of the vehicle under different contexts.

In some embodiments, the disclosed techniques can also enable one or more authorized users to grant and define access and usage permissions for a vehicle using a suitable onboard user interface coupled to the onboard computer system of the vehicle (e.g., a touchscreen coupled to the infotainment system or the like) and/or using an external system or device communicatively coupled to the onboard computer system of the vehicle via one or more wired or wireless communication networks.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments described herein.

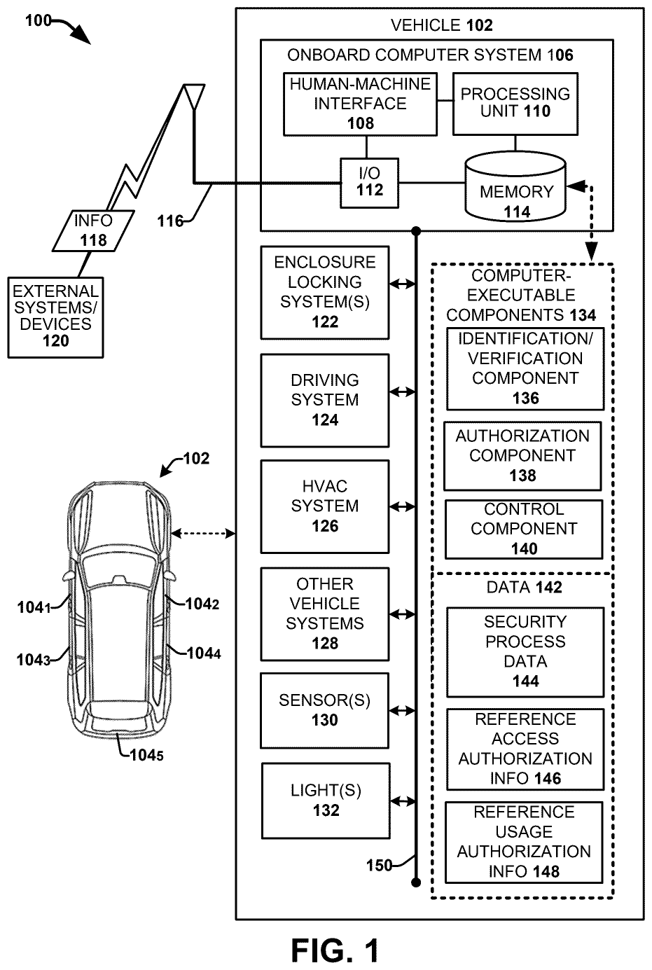

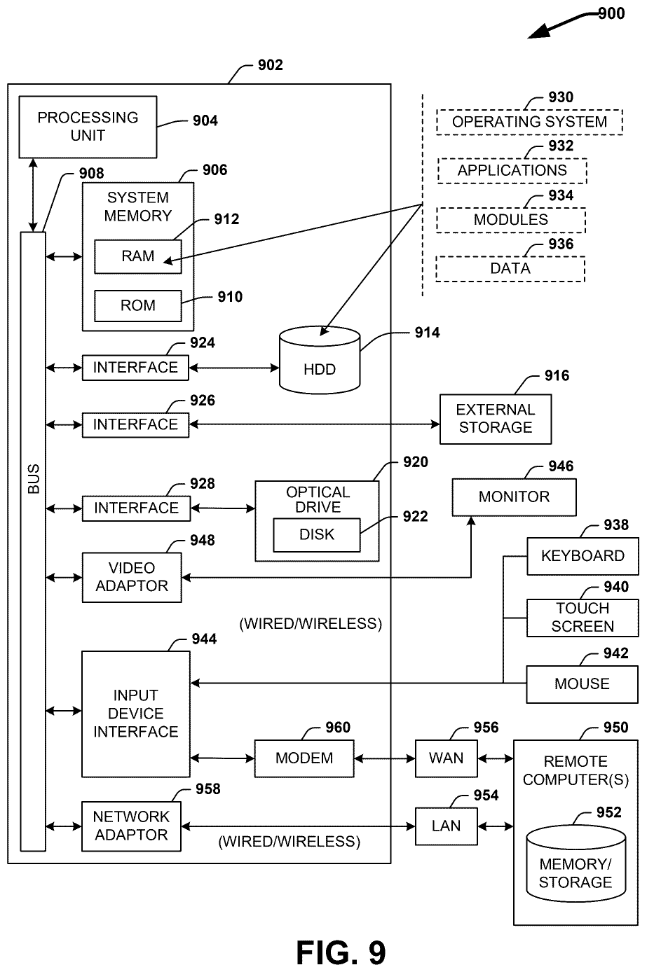

Turning now to the drawings, FIG. 1 illustrates a block diagram of an exemplary system 100 that facilitates controlling vehicle access and usage functionality based on user authentication using facial recognition and other authentication methods, in accordance with one or more embodiments described herein. System 100 comprises a vehicle 102 with an onboard computer system 106 and comprising a memory 114 that stores computer-executable components 134 and data 142 that facilitate controlling (physical) keyless access and one or more functionalities of the vehicle based on user authentication using facial recognition and other authentication methods disclosed herein. The onboard computer system 106 includes at least one processor or processing unit 110 that executes the computer-executable component 134 stored in memory 114 to carry out the operations/functions described with respect to the corresponding computer-executable components. Examples of said memory 114, processing units 110, and other computer system components that can be included in the onboard computer system 106 to facilitate the various features and functionalities of system 100 can be found with reference to FIG. 9 (e.g., system memory 910, processing unit 904, and the like).

The onboard computer system 106 can further include an input/output (I/O) component 112, wherein the I/O component 112 can be a transceiver configured to enable transmission/receipt of information 118 between the onboard computer system 106 and various external systems or devices 120. For example, the external systems or devices 120 can correspond to any type of device or computing system configured to wirelessly communicate (e.g., using radio frequency signals) with the onboard computer system 106, such as but not limited to, a mobile device associated with one or more users of the vehicle 102 (e.g., a smartphone, a smartwatch, a tablet, or another type of wearable device), an external computer, an external computer system, an external application server, another vehicle's onboard computer system, and so on. The I/O component 112 can be communicatively coupled, via an antenna 116, to the remotely located devices and systems (e.g., external systems/devices 120). Any suitable technology can be utilized to enable the various embodiments presented herein, regarding transmission and receiving of information 118 between the onboard computer system 106 and one or more external systems/devices 120. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

The onboard computer system 106 can also include a human-machine interface 108 that provides for receiving user input in association with utilizing the various features and functionalities of the computer-executable component 134 and presenting information to users. For example, the human-machine interfaces 108 can include or correspond to any suitable output device such as a display, a speaker, etc. and any suitable input device, such as a touchscreen display, a microphone, a keypad, a keyboard, and the like. Examples of suitable input and output devices of the human-machine interface 108 devices are further provided with reference to FIG. 9.

Vehicle 102 can correspond to any type of vehicle comprising one or more internal compartments (e.g., the main cabin, the trunk, and other types of compartments) that are accessed via one or more enclosures 104₁₋₅ (e.g., doors, passenger doors, a hood enclosure, a trunk enclosure, etc.) that can be electrically locked and unlocked by the onboard computer system 106 (e.g., via control component 140) and one or more respective enclosure locking systems 122 coupled thereto. For instance, vehicle 102 can include or correspond to any type of motor vehicle (e.g., a car, a truck, a van, a sport utility vehicle (SUV), etc.). In some implementations vehicle 102 can also include or correspond to an aircraft (e.g., an airplane, a helicopter, or the like), a watercraft, or another type of passenger transportation vehicle. In some embodiments, vehicle 102 can include or correspond to an autonomous vehicle that is capable of navigating and operating without (or some) human input.

In this regard, vehicle 102 can comprise various electrical and electromechanical systems that are coupled to the onboard computer system 106 via a system bus 150 (and/or via any suitable wired or wireless communication technology), including but not limited to, one or more enclosure locking systems 122, a driving system 124, an HVAC system 126 and various other vehicle systems 128 (e.g., an infotainment system, a navigation system, and autonomous driving system, and so on). Vehicle 102 can also include one or more sensors 130 and lights 132 coupled to the onboard computer system 106 that facilitate various features and functionalities of the computer-executable components 134 described below.

The one or more enclosure locking systems 122 can include or correspond to electromechanical locking devices that are coupled to the respective enclosures 104₁₋₅ and that mechanically lock to prevent the respective enclosures from being opened, and mechanically unlock to enable the respective enclosures to be opened, via corresponding electrical control signals applied thereto by the onboard computer system 106 (e.g., via control component 140).

In accordance with various embodiments, the onboard computer system 106 can provide a keyless entry functionality for vehicle 102 based on authenticating a person accessing or attempting to access one or more internal compartments of the vehicle via one or more of the enclosures 104₁₋₅. In other words, the onboard computer system 106 can control locking and unlocking of the respective enclosures without usage of a physical key or external device such as a key fob or the like. More particularly, the onboard computer system 106 can control locking and unlocking of the respective enclosures based on authentication of the person or persons attempting to access the vehicle 102 based on biometric data captured of the person or persons at the time of attempted or requested access via one or more sensors 130 integrated on or within the vehicle. To facilitate this end, the computer-executable be components can include (but are not limited to) identification/verification component 136, authorization component 138, and control component 140.

In one or more embodiments, the identification/verification component 136 can perform an entity identification/verification process (e.g., as defined in security process data 144) to identify and verify an identity of a person desiring (or presumably desiring) to access one or more internal compartments of the vehicle 102 based on biometric data captured of the person via at least one sensor of the one or more sensors 130 and reference identity verification data for one or more defined identities. For example, the reference identity verification data can be stored in memory 114 (e.g., as included in reference access authorization information 146) and provide corresponding reference biometric data for one or more defined identities. For instance, the reference access authorization information 146 can include or correspond to an index defining one or more user identities (e.g., as defined using unique identifiers for the respective identities, such as names, usernames, identification numbers, etc.) and includes registered biometric data for the respective user identities that can be used to uniquely identify the respective users (e.g., one or more facial images, one or more voice samples and/or voice signatures, one or more fingerprint signatures, one or more iris/retina signatures, etc.) in accordance with the entity identification/verification process used (e.g., a facial recognition process, a voice recognition process, or another processes involving other identity verification/authentication checks). In this regard, and the identification/verification component 136 can identity and verify the identity of a person attempting to access the vehicle 102 based on matching (e.g., relative to a defined degree of similarity) of currently captured biometric data of a person (via the one or more sensors 130) with corresponding reference biometric data for the person stored in memory 114.

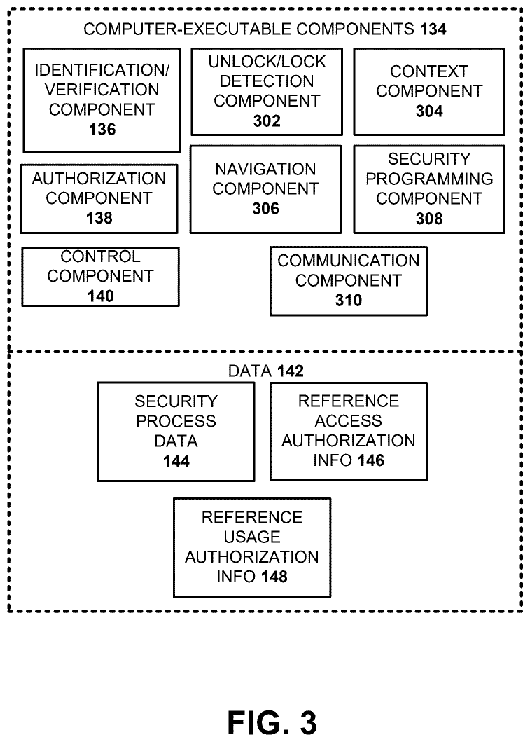

The authorization component 138 further determines access authorization information regarding whether the person is authorized to access one or more internal compartments of the vehicle 102 based on verification of the identity of the person in accordance with the entity identification/verification process and reference access authorization information 146 defining access permissions for the one or more defined identities. For example, the reference authorization information 146 can further indicate whether each identity is authorized to access one or more internal compartments of the vehicle or not. In some embodiments, the access can be tailored to one or more different internal compartments of the vehicle (e.g., all internal compartments, the main cabin only, the trunk only, and so on). With these implementations, the reference access authorization information 146 can also define which internal compartment each identity is authorized to access. Still in other embodiments, the access can be restricted based on context and the reference access authorization information 146 can define any contextual restrictions on access of each defined identity (e.g., as described in greater detail infra with reference to FIG. 3).

The control component 140 further controls access to the one or more internal compartments via electronically controlling unlocking and locking of corresponding enclosures of the one or more internal compartments (e.g., via issuing corresponding unlocking/locking control signals to the corresponding enclosure locking systems 122 coupled to the enclosures) in accordance with the reference access authorization information defined for the person/identity. For example, based on a determination by the authorization component 138 that an identified and verified person desiring to access one or more compartments of the vehicle is authorized to do so (e.g., as defined in the reference access authorization information 146), the control component 140 can unlock the one or more enclosures to the corresponding compartments.

In various embodiments, the biometric data used to identify and verify the identity of a person desiring to unlock one or more doors of the vehicle 102 comprises facial image data of the person and the identification/verification process performed by the identification/verification component 136 comprise a facial recognition process. With these embodiments, the one or more sensors 130 can include at least one camera configured to capture the facial image data of the person in association with detecting the person desires to access the vehicle 102. In various embodiments, the camera can include or correspond to one or more existing cameras integrated on or within the vehicle that are used for other functions and/or systems of the vehicle, such as a back-up camera, one or more autonomous navigation system cameras, or the like. In other embodiments, the camera can include or correspond to a camera positioned on or within the vehicle that provides a natural line of sight to the position of a person's face as located outside of the vehicle (e.g., as tailored based on the person's height and/or distance from the vehicle 102).

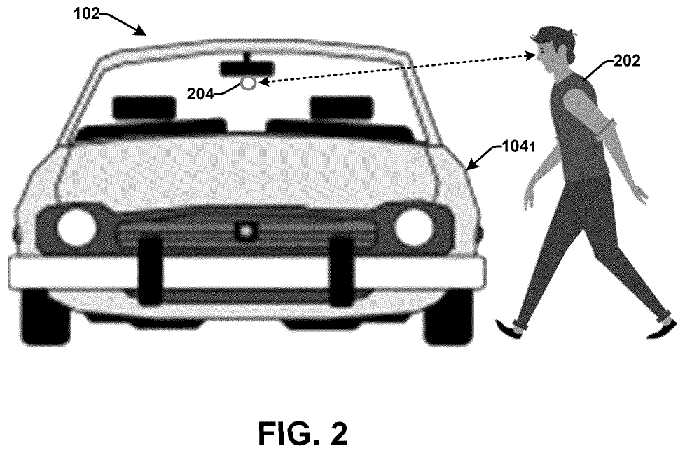

For example, FIG. 2 illustrates an example implementation of vehicle 102 incorporating facial recognition-based entry in accordance with one or more embodiments described herein. As illustrated in FIG. 2, vehicle 102 includes a camera 204 positioned on or near the rear-view mirror of vehicle 102. With this position, the camera 204 provides a perspective of the face of a person 202 approaching and facing enclosure 104₁ of the vehicle 102. With this position, the camera 204 also provides a clear perspective throughout all windows of the vehicle 102 on all sides of the vehicle 102. For example, in some implementations, the camera 102 can provide a 360-degree field of view (FOV) around all sides of the vehicle so as to enable capturing image data (e.g., still images and/or video) of the environment around the vehicle, including faces of persons desiring to enter the vehicle via one or more of the enclosures 104₁₋₅. In another example, as the vehicle is typically opened by a person desiring to drive the vehicle, the camera can be positioned with a perspective external to the driver's side door. In another example, the camera can be positioned anywhere that provides a perspective view of the external environment, regardless of which door or doors of the vehicle are desired to be opened. To this end, authorized users of the vehicle can previously know the position of such camera required for facial recognition access and position themselves in front of such camera to request access to the vehicle, regardless of which enclosure or enclosures each person is authorized to open. In this regard, it should be appreciated that the position of the camera 204 can vary and that a plurality of cameras may be used to capture the facial image data of the person 202 depending on the position of the person 202 relative to the vehicle 102.

With reference to FIGS. 1 and 2, additionally, or alternatively, the biometric data used by the identification/verification component 136 to identify and verify the identity of a person desiring to access the vehicle 102 can include but is not limited to, body image data, voice data, fingerprint data, iris/retina data and/or gesture data. With these embodiments, the one or more sensors 130 can include corresponding sensors configured to capture the respective types of biometric data. For example, in addition to one or more cameras, the one or more sensors 130 can include, but are not limited to, an acoustic sensor or microphone, a fingerprint scanner, an iris/retina scanner, and the like. In this regard, the one or more sensors 130 can include but are not limited to, cameras, optical sensors, laser sensors, Light Detection and Ranging (LiDAR) sensors, sonar sensors, audiovisual sensors, perception sensors, motion detectors, proximity sensory, velocity sensors, and the like, as employed in such applications as simultaneous localization and mapping (SLAM), and other computer-based technologies and methods utilized to detect and determine information regarding body/object movement and the like.

For example, in other implementations, the entity identification/verification process can involve using image data captured of the person's body via camera 204 or the like, that uniquely identifies the person (e.g., based on their unique physical form, based on one or more unique birthmarks, based on one or more unique tattoos, hair color, skin color, etc.). In another example, the entity identification/verification process can involve using voice recognition to uniquely identify a person based on their voice. With these implementations, the one or more sensors 130 can include at least one acoustic sensor located on or within the vehicle 102 configured to capture a voice sample provided by the person in association with requesting access to one or more internal compartments of the vehicle. In another example, the entity identification/verification process employed by the identification verification component 136 (e.g., as defined in the security process data 144) can involve identifying and verifying the identity of a person attempting to access the vehicle based on their gestures, gait, mannerisms and the like.

In another example, the entity identification/verification process can be based on the person providing a unique signal used to identify themselves and/or to indicate a request to unlock one or more enclosures of the vehicle. With these implementation, the unique signal can correspond to a unique password and each registered user can have their own unique password (as stored in with their identity or user profile information in the reference access authorization information 146) to uniquely represent and/or verify their identity. For example, the unique signal can correspond to a unique gesture (e.g., a hand gesture, an arm gesture, or any type of gesture involving one or more body parts), a unique sequence of gestures, a unique body position or sequence of body positions or the like that can be detected by the camera 204. In accordance with this example, the unique signal can correspond to a gesture-based password, wherein based on the person providing the unique gesture, the identification/verification component 136 can identify the person (e.g., based on the unique gesture being registered for the person/identity in the reference access authorization information 146). In yet another example, the unique signal can include or correspond to a spoken password or phrase that uniquely identifies a particular person (e.g., based on the unique verbal password being registered for the person/identity in the reference access authorization information 146), wherein based on the person providing the unique password or phrase (e.g., as spoken by the person and received via one or more acoustic sensors integrated on or within the vehicle 102), the identification/verification component 136 can identify and verify the identity of the person.

In some embodiments, the entity identification/verification process performed by the identification/verification component 136 can involve using a security application executed on external device (e.g., external to the vehicle) associated with the person attempting access, such as a smartphone, a smartwatch or the like, that communicates a digital key with the onboard vehicle computer system instructing the onboard vehicle computer system to open the vehicle following authentication of the person.

In some implementations, the entity identification/verification process can employ a combination of two or more different entity verification checks to authenticate the identity of the person attempting to access the vehicle. To this end, identification/verification process can be based on a combination of any of the different identity verification mechanisms discussed herein. For example, the entity identification/verification process to be applied by the identification/verification component 136 to determine and verify the identity of a person desiring to access the vehicle 102 can be based on a combination of two or more different biometric based identity verification checks. In another example, the identification/verification process can be based on provision of one or more unique signals (e.g., gesture-based signals and/or voice-based signals) and/or a defined sequence of unique signals.

To this end, the security process data 144 can define the particular entity identification/verification process to be applied by the identification verification component 136 to identify and verify the identity of a person attempting to access the vehicle, which can include a verification check based on a single type of biometric data (e.g., facial recognition), a combination of two or more types of biometric data (e.g., facial data, voice data, iris/retina data, body image data, gesture data, etc.), and/or a combination of biometric data and other types of verification methods (e.g., provision of a unique signal or sequence of signals corresponding to a unique password, and so on). In some embodiments, the particular identification/verification process to be applied by the identification/verification component 136 can vary for different users/people and contexts (e.g., as described in greater detail with reference to FIG. 3). In this regard, in some embodiments, the authorization component 138 can be configured to only authorize opening one or more enclosures of the vehicle 102 in response to verification that the person is authorized to do so (e.g., as defined for the respective user identities in the reference access authorization information 146) based on the determining and verifying the identity of the user in accordance with applicable the identification/verification process.

In some embodiments, in addition to controlling access to the vehicle 102 for a person based on determining/verifying the identity of the person and determining that the identity/person is authorized to do so, the control component 140 can also control usage of one or more functionalities of the vehicle based on the identity of the person. For example, the memory 114 of vehicle 102 can also store reference usage authorization information 148 linking defined user identities (e.g., biometric data, usernames, unique identifiers, etc.) to vehicle usage permissions. In this regard, the usage permissions can relate to one or more operating functionalities of the vehicle that the user is authorized (or not authorized) to utilize, such as the driving functionality of the vehicle provided by the driving system 124, the functionalities of the HVAC system 126, and various other functionalities of other vehicle systems 128 (e.g., the infotainment system functionalities for instance and others). For example, the usage permissions may allow one user to enter and employ the driving functionality of the vehicle and another user to only access the vehicle to retrieve something from the main cabin or trunk of the vehicle yet not use the driving functionalities of the vehicle. In another example, the usage permissions may allow another user identity to enter the main cabin and use the HVAC and infotainment system yet not use the driving functionality of the vehicle. In some embodiments, the usage permissions can also be tailored based on context (e.g., time of day, day of week, location, and other contextual parameters) and/or relate to preferred user settings of the vehicle functions, as described infra with reference to FIG. 3.

The control component 140 can further automatically control activation and deactivation of the operating functionalities of the vehicle in accordance with the usage permissions as defined for the respective user identities in the reference usage authorization information 148. For example, the control component 140 can automatically start the vehicle (i.e., start the ignition thereof) or enable the user to start the vehicle (e.g., via a push button located inside the vehicle or the like) based on the user having permission to start the vehicle and issuing corresponding control signals to the driving system 124 of the vehicle 102. In another example, the control component 140 can automatically turn on the HVAC system 126, the infotainment system, or another electrical system of the vehicle (or enable the user to turn on the respective systems via corresponding input commands, such as push-button commands, gesture commends, voice commands or the like) based on the user identity having permission to do so (e.g., as defined, in the reference usage authorization information 148) and issuing corresponding control signals to the respective electrical systems of the vehicle 102. For example, the usage permissions can restrict usage of the driving functionality of the vehicle to a particular identity based on a particular context (e.g., time of day, day of week, location, route, speed, etc.). In some implementations, the usage permissions can also include or correspond to settings regarding preferences of the identity with respect to various features and functionalities of the vehicle and the onboard computer system can automatically configure the features and functionalities in accordance with the settings for a given usage scenario by an authorized identity. For example, the settings information can relate to settings of any onboard vehicle system or device that can be electronically controlled by the onboard computer system of the vehicle, such as seat position settings, HVAC settings, infotainment settings, navigation/route settings, and so on.

FIG. 3 illustrates a block diagram of example computer-executable components 134 of the onboard computer system 106 of vehicle 102 that facilitate controlling vehicle access and usage functionality, in accordance with one or more embodiments described herein. As shown in FIG. 3, in some embodiments, in addition to the identification/verification component 136, the authorization component 138 and the control component 140, the computer-executable components 134 can also include unlock/lock detection component 302, context component 304, navigation component 306, security programming component 308 and communication component 310.

With reference to FIGS. 1-3, in some embodiments, the unlock/lock detection component 302 can determine or facilitate determining when a person external to the vehicle 102 desires to unlock and lock respective enclosures of the vehicle 102. For example, in accordance with some embodiments in which facial recognition and/or other biometric based user identity/verification mechanisms are employed to unlock one or more enclosures to the vehicle, as a person approaches the vehicle in locked state and becomes within a defined distance relative to the vehicle 102, the identification/verification component 136 can automatically initiate the identification/verification process and unlock the vehicle based on identification/verification of the identity of the person and a determination (e.g., via the authorization component 138) that the identity is authorized to access the vehicle. For example, using one or more proximity sensors, motion sensors, cameras or the like, the unlock/lock detection component 302 can detect a person approaching the vehicle and direct the corresponding biometric sensors (e.g., cameras, acoustic sensors, etc.) to capture the biometric data for the person (e.g., image data, facial image data, voice data, iris/retina data, etc.), and the identification/verification component 136 can perform the identification/verification process using the captured biometric data in order to automatically unlock the vehicle if/authorized for the person.

However, in accordance with these embodiments, it can be appreciated that users authorized to access the vehicle may be positioned within the defined distance of the vehicle yet not desire to have the vehicle automatically unlocked, such as when they are leaving the vehicle and desire for the vehicle to remain locked, walking past the vehicle or the like. Likewise, it can be appreciated that activating the camera 204 and other biometric sensors in response to detection of any person (or object other than a person), including unauthorized persons within the defined distance of the vehicle, to capture biometric data and performing the identification/verification process to potentially unlock the vehicle can be a wasteful utilization of the sensor's power supply and computing resources (e.g., processing power and power supply) of the onboard computer system 106, especially in scenarios in which the vehicle is located in high pedestrian traffic areas (e.g., busy parking lots or the like).

Thus, in various embodiments, the unlock/lock detection component 302 can provide one or more mechanisms to control activation of the requisite biometric data capturing sensors of the vehicle 104 and performance of the identity/verification process in association with utilization thereof to unlock the vehicle to restrict activation and performance to scenarios in which a person clearly desires to unlock the vehicle. With these embodiments, the security process data 144 can define conditions and/or signals that correspond to a request to unlock the vehicle (or more particularly one or more enclosures thereof), and the unlock/lock detection component 302 can determine when a person is requesting to unlock the vehicle when the conditions/signals are met or otherwise received. With these embodiments, in response to a determination by the unlock/lock detection component 302 that a person external to the vehicle 102 desires to unlock and one or more enclosures of the vehicle, the unlock/lock detection component 302 can direct the identification/verification component 136 to initiate performance of the entity identification/verification process in association with utilization thereof to unlock the vehicle. This can involve temporarily activating necessary sensors (of the one or more sensors 122) to capture the requisite biometric data used by the identification/verification component 136 to identify and verify the identity of the person in accordance with the applicable entity identification/verification process.

Likewise, in some implementations, in response to a determination that the vehicle should be locked, the unlock/lock detection component 302 can direct the control component 140 to lock the respective enclosures of the vehicle. In some embodiments, the control component 140 can be configured to automatically lock the vehicle unless an explicit request to unlock the vehicle is received. The control component 140 can also be configured to automatically lock the vehicle based on defined conditions or criteria being met (e.g., as determined via the unlock/lock detection component 302 based on monitoring the vehicle 102 environment and context via the one or more sensors 130 and/or other contextual data input), such as following a defined time window after unlocking, following closing of the enclosure or enclosures after unlocking an opening thereof, following exiting of the vehicle by respective passengers, and other contextual-based criteria, events or conditions.

Various conditions and/or signals can be employed to indicate when a person external to the vehicle 102 desires to unlock one or more enclosures of the vehicle 102. In some embodiments, the conditions or signals can correspond to a person approaching and facing the vehicle and becoming a defined distance relative to the vehicle or one or more enclosures of the vehicle). Additionally, or alternatively, the conditions or signals can correspond to touching, pointing to, or otherwise engaging a handle (e.g., a door handle) of a locked enclosure, as detected by the unlock/lock detection component 302 using one or more contact sensors integrated on or within the door handles, motion sensors, and/or cameras (e.g., included in the one or more sensors 130). For example, in some implementations of these embodiments, the respective door handles can include contact sensors. In other implementations, motion sensors can be used to detect motion nearby the vehicle, which in turn can cause the onboard computer system 106 to activate one or more cameras with a perspective of the environment around the vehicle to capture image data of the environment which. The sensory data can be analyzed via the unlock/lock detection component 302 using various object localization and/or tracking mechanism to determine relative object position, object movement, orientation and so on. For example, the unlock/lock detection component 302 can analyze the image data to determine whether a person around the vehicle desires to unlock the vehicle based on the person touching, pointing to, or otherwise engaging a handle (e.g., a door handle) of an enclose in the captured image data.

In other implementations, motion sensors can be used to detect motion nearby the vehicle, which in turn can cause the onboard computer system 106 to activate one or more cameras with a perspective of the environment around the vehicle and/or other sensors configured to capture sensory data. With these implementations, an expressed signal in the form of a voice command, gesture, sequence of gestures, and/or body position of the person relative to the vehicle (e.g., such as standing at a particular position relative the vehicle and facing the camera 204, a microphone or the like), or the like, can be used to indicate a request unlock the vehicle.

In some embodiments, the unlock/lock detection component 302 can also control activation of one or more lights 132 integrated on or within the vehicle in association with capturing image data of the external environment of the vehicle 102 (e.g., via camera 204 and/or other cameras integrated on or within the vehicle) in contexts in which the external environment is dimply lit or dark (e.g., relative to a defined degree of brightness). For example, in association with activating the one or more cameras to capture facial image data of a person in the external environment and/or other image data of the external environment in dark or dimply lit conditions, the unlock/lock detection component 302 can temporarily activate one or more lights 132 to improve the brightness and quality of the image data captured.

As noted above, in some embodiments, various features and functionalities of the identification/verification component 136 and the authorization component 138 can be tailored based on context. In this regard, in some embodiments, the particular identity/verification processes to be applied by the identification/verification component 136 can be tailored based on context (e.g., time of day, day of week, location of the vehicle, weather, and other contextual factors). In other words, the security process data 144 can define different security processes to be used for different context in association with enabling/disabling access to the vehicle and/or enabling/disabling various usage functionalities of the vehicle for an authenticated person, depending on the context of the vehicle 102. The different security processes can vary with respect to the number and/or type of security checks applied so as to provide different levels of security under different contexts. For example, in some implementations, the security process data 144 can define a heighted identity/verification process for locations of the vehicle other than a vehicle user's home location, and/or for geographical locations classified as high crime risks or otherwise associated with a high-risk event (e.g., a current/recent criminal event at or near the location or the like). For instance, a low or moderately robust identity/verification process based on one or two different identity/verification checks (e.g., facial recognition based, voice recognition based, etc., verbal/gesture-based password based, etc.) may be applied for defined low risk locations, and more robust identity/verification process (providing a higher level of security) based on higher number of identity/verification checks may be applied for defined high risk locations. In another example, the context can be based on time of day, day of week, weather and other contextual factors. For instance, the other contextual factors can account for the current external environment of the vehicle, including but not limited to, a level of activity in the environment a number of people in the environment, a number of unauthorized people in the environment, and so on (e.g., wherein the level of security associated with security process employed can increase relative to the level of activity, number of people, number of unauthorized people, etc.). In another example, in scenarios in which the weather conditions are not conducive for a user of the vehicle to perform a robust identity/verification process involving multiple security checks (and thus a longer duration of time) to unlock and enter their vehicle (e.g., when its raining, snowing, extremely high/low temperatures, etc.), a more speedy identity/verification process can be automatically applied (e.g., based on a single security check, such as facial recognition only or provision of a verbal/gesture based password only).

The reference access authorization information 146 defined for one or more users of the vehicle 102 can also be tailored based on context. In this regard, as described above, different users of vehicle 102 can have different access permissions with respect to which internal compartments they are authorized to access (e.g., all internal compartments, the main cabin only, the trunk only, and so on). In addition, the reference access authorization information 146 defined for a particular user identity of the vehicle 102 can vary based on context, such as vehicle location, time of day, day of week, weather, the external environment of the vehicle, other contextual factors. For example, the reference access authorization information 146 defined for a particular user identity may restrict access to one or more internal compartments of the vehicle as a function of a location of the vehicle, a timeframe, or the like.

The reference usage authorization information 148 defined for one or more users of the vehicle 102 can also be tailored based on context. In this regard, as described above, different users of vehicle 102 can have different usage permissions with respect to whether and which operating functionalities of the vehicle the authorized to utilized following granting of access to the vehicle 102. For instance, one user may be allowed to enter and start the vehicle and utilize the driving functionality of the vehicle (e.g., provided by the driving system 124 while another may only be allowed to enter the vehicle to retrieve something or sit in the vehicle and use the HVAC system 126 and/or one or more other vehicle systems 128 (e.g., the infotainment system for instance and others). To this end, the control component 140 can control usage of one or more operating functionalities of the vehicle by respective users of the vehicle based in accordance with their respective reference usage authorization information. For example, based on a determination by the authorization component 138 that a user identity is authorized to utilize a particular operating functionality of the vehicle (e.g., as defined in the reference usage authorization information 148 for the particular user identity), the control component 140 can automatically control activation (or turning on) of the particular operating functionality and/or enable the user to activate, turn on, or otherwise use the particular operating functionality (e.g., via corresponding push buttons or other types of user-machine interface 108 input/control mechanisms for the respective electrical systems of the vehicle) without requiring the user to have a physical vehicle key, key fob or the like.

In addition, the reference usage authorization information 148 defined for a particular user identity of the vehicle 102 can vary based on context, such as vehicle location, time of day, day of week, weather, the external environment of the vehicle, route other contextual factors. For example, the reference usage information 148 defined for a particular user identity may restrict usage of the driving system 124 (and thus driving functionality of the vehicle) of the vehicle to one or more locations, geographical areas, timeframes, weather conditions or the like. In some implementations of the embodiments, the context can also account for route and/or duration of usage. For example, the reference usage information the reference usage information 148 defined for a particular user identity may restrict usage of the driving system 124 to a particular route and/or duration of usage and the control component 140 can control usage of the driving functionality accordingly (e.g., by preventing activation thereof outside the designated route and/or usage duration). The usage permissions can also be tailored to account for various features of the respective operating systems under different contexts and/or for different user identities, such as speed, driving mode (e.g., autonomous driving mode verses automatic driving mode), HVAC settings, infotainment settings, and so on. In some implementations, the usage permissions can also include or correspond to settings regarding preferences of the respective user identities with respect to various features and functionalities of the electrical and/or electromechanical systems of the vehicle 102, and the control component 140 can automatically configure the features and functionalities in accordance with the settings for a given usage scenario or context by an authorized identity. For example, the settings information can relate to settings of any onboard vehicle system or device that can be electronically controlled by the onboard computer system of the vehicle, such as seat position settings, HVAC settings, infotainment settings, navigation/route settings, and so on, which can also be tailored based on context of the vehicle and a particular user identity. In some implementations, the context can also account for the current level of power supply available to the vehicle (e.g., gasoline level and/or battery level for battery operated vehicle). For example, based the reference usage authorization information 146 defined for one or more user identities can restrict or limit usage of one or more operating functionalities of the vehicle 102 and/or the duration of usage thereof (e.g., driving duration, HVAC system usage duration, etc.) based on the level of power supply being low (e.g., relative to one or more defined threshold levels).

To this end, to facilitate controlling vehicle access and usage functionalities for respective user identities based on various contextual factors discussed herein (and others), the context component 304 and determine and monitor the context of the vehicle 102. For example, the context component 304 can determine and/or monitor the vehicle location, time of day/day of week, weather, external environment of the vehicle, route of the vehicle, speed of the vehicle, power supply level of the vehicle and so on. For example, the context component 304 can determine and/or monitor the context of the vehicle based on sensory data captured via the one or more sensors 130, location and/or route information provided by an onboard navigation component 306 (utilizing any suitable location/navigation technology), and integration with the respective vehicle electrical and/or electromechanical systems (e.g., the driving system 124, the HVAC system 126 and the other vehicle systems 128). The context component 304 can also access and employ relevant context information provided by various external resources (e.g., one or more external systems/device 120) as accessed via one or more wired or wireless communication networks. For example, using communication component 310, input/output component 112 and/or antenna 116, the context component 134 can access various, network accessible systems and devices providing relevant information about the vehicle environment, weather conditions, current events, high/low-risk locations, and so on. To this end, communication component 310 can correspond to suitable software and/or hardware employable by the onboard computer system 106 to wirelessly communicate information 118 between the onboard computer system 106 and one or more external systems/devices 120.

In some embodiments, as applied to controlling the driving functionality of the vehicle 102, the context can also account for the internal environment of the vehicle and the seat position of the authorized driver. In this regard, in many scenarios, two or more people may enter vehicle 102 following unlocking thereof in response to authorizing unlocking of the main cabin of the vehicle in accordance with the disclosed techniques. However, only one of the people may be authorized to drive the vehicle. With these scenarios, the context component 304 can assess the internal environment of the vehicle (e.g., based on image data captured of the internal environment via one or more cameras) to determine whether the authorized driver is seated in the driver's seat (e.g., using facial recognition technology, or another biometric based identity verification technology). The control component 140 can further restrict the vehicle from being driven (e.g., prevent usage of the driving functionality of the vehicle) based on whether the authorized driver is seated in the driver's seat. For example, the control component 140 can prevent the vehicle from being started and driven if the authorized diver is not located in the driver's seat.

As described above, information defining and controlling the security processes (e.g., the one or more entity identification verification processes to be applied by the identification/verification component 136), the user access permissions and the user usage permissions can respectively be defined in the security process data 144, the reference access authorization information 146 and reference usage authorization information 148. In various embodiments, this information can be entered or otherwise generated and stored in memory 114 using security programming component 308. For example, the security programming component 308 can enable one or more authorized entities to define and program, via one or more electronic input devices coupled to the onboard computer system 106, the identity verification process as tailored to the one or more defined identities, the reference identity verification data (e.g., user identity reference biometric data (e.g., reference user facial images, reference user voice signatures, reference user fingerprint signatures, etc.), verification gesture-voice based password data, etc.), the reference access authorization information 146, and the reference usage authorization information 138. For example, in some embodiments, the one or more electronic input devices can include one or more input devices of the human-machine interface and/or coupled to the infotainment system of the vehicle. In another example, the one or more electronic input devices can include any external device (e.g., of external systems/device 120 coupled) coupled to the onboard computer system 106 via any suitable wired or wireless communication technology.

For example, in some implementations, using any suitable input device coupled to the onboard computer system 106, an owner or another authorized user of the vehicle can provide information registering one or more users authorized to access and/or utilize the operating functionalities of the vehicle and provide the reference biometric information for the respective users and their respective user identifiers (e.g., names, usernames, another unique identifier). The authorized user can further enter information defining the applicable entity identification/verification process to be applied (including any contextual variations applicable), their access permissions (including any contextual variations applicable), and their usage permissions (including any contextual variations applicable). For example, in some implementations, using an external device (e.g., an external computer, smartphone or the like), an authorized user located anywhere remote from the vehicle can program the vehicle with such information for a given person to allow any person to access the vehicle and/or use one or more operating functionalities of the vehicle in accordance with the parameters provided and defined by the authorized user. For instance, the authorized user can allow and enable any friend or family member to temporarily access and use the vehicle without having a physical key or key fob for the vehicle. In another example, an authorized user can allow and enable any service personal (e.g., a vehicle repair service, a tow truck service, or the like) to temporarily access and use the vehicle without having a physical key or key fob for the vehicle. In yet another example as applied to rental cars, an authorized rental car operator can allow and enable any vehicle renter to temporarily access and utilize the vehicle for the agreed rental period using the keyless entry and usage functionality techniques described herein.

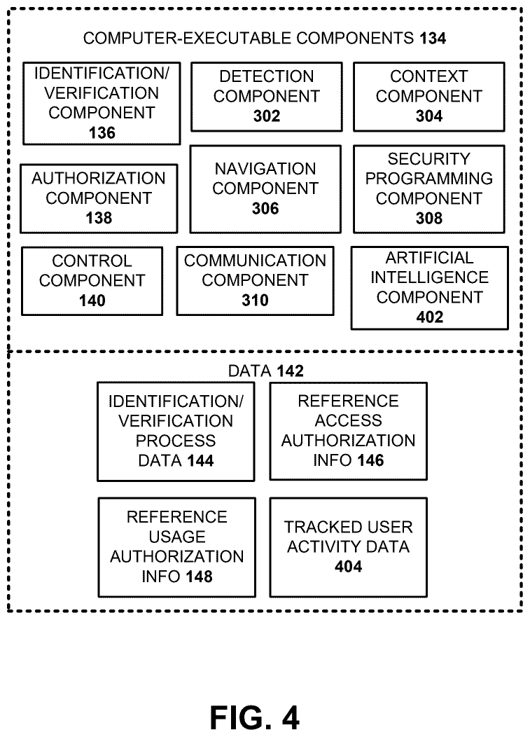

FIG. 4 illustrates a block diagram of additional example computer-executable components of an onboard computer system of a vehicle that facilitate controlling vehicle access and usage functionality, in accordance with one or more embodiments described herein. In some embodiments, the computer-executable components 134 can further include artificial intelligence component 402 (hereinafter AI component 402) and the data can further include tracked user activity data 404. Repetitive description of like elements employed in respective embodiments is omitted for sake of brevity.

In some embodiments, in addition to and/or alternative to having one or more authorized users program the security process data 144, the reference access authorization information 146, and/or reference usage authorization information 148, the AI component 402 can employ various AI and/or machine learning techniques to automatically, learn, generate and adapt this information for respective users of the vehicle based on tracked user activity data 404 for the respective users and other relevant information accessible to the onboard computer system 106 via any suitable wireless communication network (e.g., the Internet) at various relevant data sources. For example, the tracked user activity data 404 can include or correspond to information tracked for one or more authorized users of the vehicle, including their biometric data, their vehicle access activity over time and with respect to various contexts, and the vehicle usage activity over various contexts. The other relevant information sources can include aggregated user activity data for other vehicles under same and disparate contexts, information pertaining to forecasted weather, information pertaining to the current and forecasted environment at the vehicle's current and future location, and other relevant contextual data.

To this end, the AI component 402 can learn the optimal security measures to be applied for respective users under different contexts, the optimal or preferred access permissions and protocols to be applied under different contexts, the optimal or preferred usage permissions to be applied under different contexts and the optimal or preferred user settings with respect to the various features and functionalities of the electronic vehicle systems under different contexts. For example, the AI component 402 can learn, generate and adapt the reference access authorization information 146 for one or more users based on tracked biometric data captured of respective persons corresponding to the one or more defined identities captured via the one or more sensors 130 and using one or more machine learning techniques. In another example, the AI component 402 can learn, generate and adapt, the reference usage authorization information 148 based on tracked usage data regarding historical usage of the one or more operating functionalities of the vehicle by the one or more defined identities and using one or more machine learning techniques.

To facilitate this end, the AI component 402 can employ various types of machine learning techniques for learning explicitly or implicitly how to define the identification verification process data 144 for one or more user identities under different contexts, the reference access authorization information 146 for the one or more user identities under different contexts, and the reference usage authorization information 148 for one or more user identities under different contexts. Inferring or learning can employ a probabilistic or statistical-based analysis to infer an action that is to be executed. For example, in some implementations, a support vector machine (SVM) classifier can be employed. Other learning approaches that can be employed by the AI component 402 can include usage of neural networks (e.g., including deep neural networks, deep adversarial neural networks, convolutional neural networks, and the like), Bayesian networks, decision trees, a nearest neighbor algorithms, boosting algorithm, gradient boosting algorithms, linear regression algorithms, k-means clustering algorithms, association rules algorithms, q-learning algorithms, temporal difference algorithm, and probabilistic classification models providing different patterns of independence can be employed. Learning as used herein also is inclusive of statistical regression that is utilized to develop models of priority.

As will be readily appreciated from the subject specification, the subject innovation can employ learning classifiers that are explicitly trained (e.g., via a generic training data) as well as implicitly trained (e.g., via observing user behavior, receiving extrinsic information) so that the learning classifier is used to automatically determine according to predetermined criteria which action to take. For example, SVM's can be configured via a learning or training phase within a learning classifier constructor and feature selection module. A learning classifier is a function that maps an input attribute vector, k=(k1, k2, k3, k4, kn), to a confidence that the input belongs to a learning class-that is, f(k)=confidence(class).

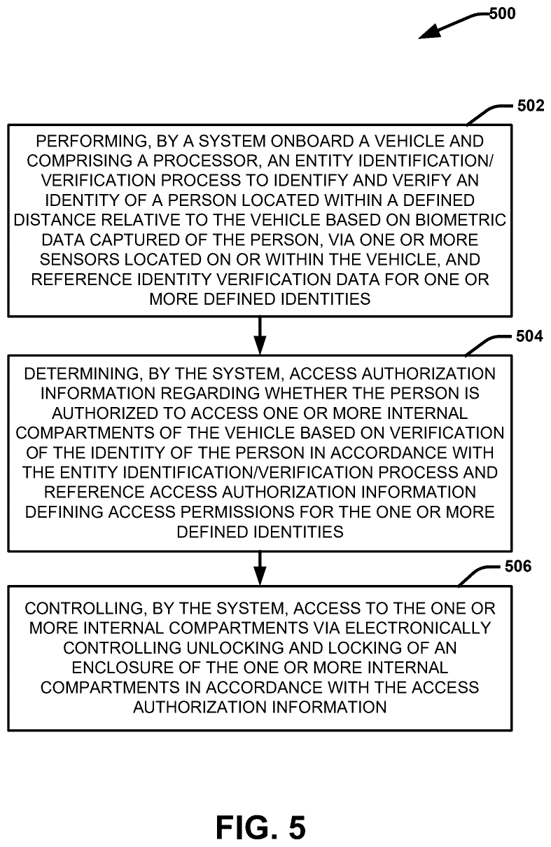

FIG. 5 illustrates a block flow diagram of an example, non-limiting computer-implemented method 500 for controlling vehicle access, in accordance with one or more embodiments described herein. Method 500 comprises, at 502, performing, (e.g., via identification/verification component 136) by a system (e.g., onboard computer system 106) onboard a vehicle (e.g., vehicle 102) and comprising a processor (e.g., processing unit 110) onboard computer system 106), an entity identification/verification process to identify and verify an identity of a person located within a defined distance relative to the vehicle based on biometric data captured of the person, via one or more sensors (e.g., sensors 122) located on or within the vehicle, and reference identity verification data for one or more defined identities (e.g., as included in identification/verification process data 144). At 504, method 500 comprises determining, by the system (e.g., via authorization component 138), access authorization information regarding whether the person is authorized to access one or more internal compartments of the vehicle based on verification of the identity of the person in accordance with the entity identification/verification process and reference access authorization information defining access permissions for the one or more defined identities. At 506, method 500 comprises, controlling (e.g., via control component 140 and one or more enclosure locking systems 126), by the system, access to the one or more internal compartments via electronically controlling unlocking and locking of an enclosure (e.g., one or more enclosures 104₁₋₅ or the like) of the one or more internal compartments in accordance with the access authorization information.

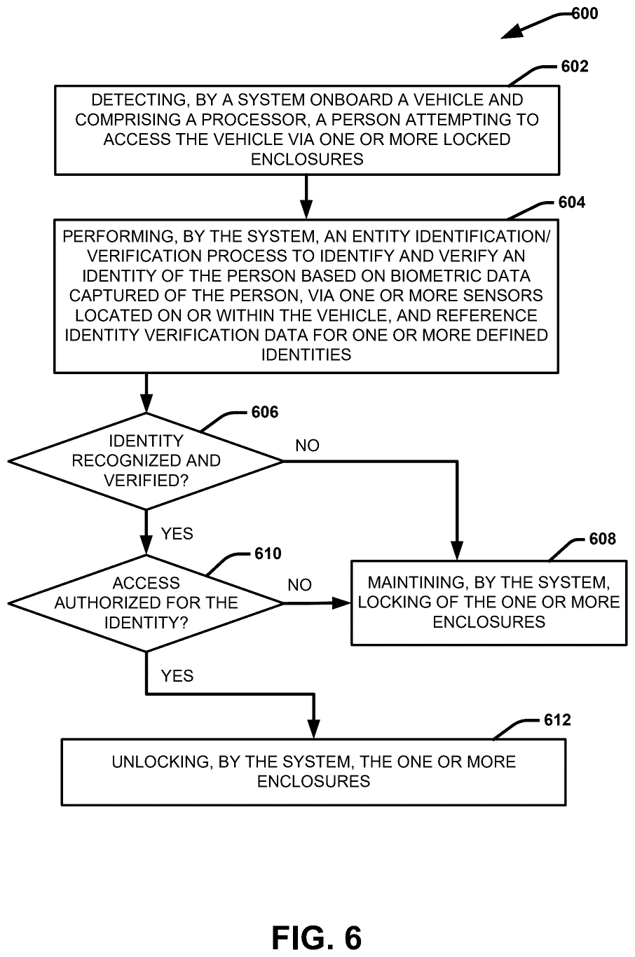

FIG. 6 illustrates a block flow diagram of another example, non-limiting computer-implemented method 600 for controlling vehicle access, in accordance with one or more embodiments described herein. Method 600 comprises, at 602, detecting (e.g., via detection component 302 and one or more sensors 122), by a system (e.g., onboard computer system 106) onboard a vehicle (e.g., vehicle 102) and comprising a processor (e.g., processing unit 110), a person attempting to access the vehicle via one or more locked enclosures. At 604, method 600 comprises performing, by the system (e.g., via identification/verification component 136) an entity identification/verification process to identify and verify an identity of a person located within a defined distance relative to the vehicle based on biometric data captured of the person, via one or more sensors (e.g., sensors 122) located on or within the vehicle, and reference identity verification data for one or more defined identities (e.g., as included in identification/verification process data 144).

At 606, if the system cannot determine and verify the identity of the person, then process 600 continues to 608, wherein the system maintains locking of the one or more enclosures. However, if at 606 the system determines and verifies the identity of the person, then at 610, the system determines whether access to the vehicle is authorized for the identity (e.g., via authorization component 138 and reference access authorization information 146). If at 610 the system determines that access is not authorized, then process 600 continues to 608, wherein the system maintains locking of the one or more enclosures. However, if at 610 the system determines that access is authorized for the identity, then process 600 continues to 612, wherein the system unlocks the one or more enclosures (e.g., via control component 140 and one or more enclosure locking systems 126).

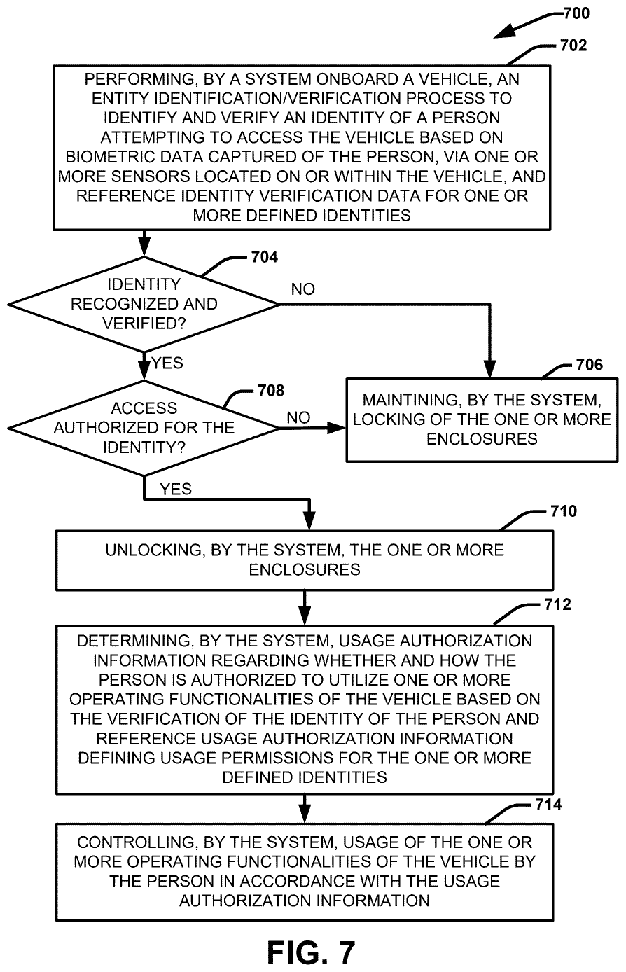

FIG. 7 illustrates a block flow diagram of an example, non-limiting computer-implemented method 700 for controlling vehicle access and usage functionality, in accordance with one or more embodiments described herein. Method 700 comprises, at 702, performing by a system onboard a vehicle and comprising a processor (e.g., onboard computer system 106 and using identification/verification component 136) an entity identification/verification process to identify and verify an identity of a person attempting to access the vehicle based on biometric data captured of the person via one or more sensors (e.g., sensors 122) located on or within the vehicle, and reference identity verification data for one or more defined identities (e.g., as included in identification/verification process data 144). At 704, if the system cannot determine and verify the identity of the person, then process 700 continues to 706, wherein the system maintains locking of the one or more enclosures.

However, if at 704 the system determines and verifies the identity of the person, then at 708, the system determines whether access to the vehicle is authorized for the identity (e.g., via authorization component 138 and reference access authorization information 146). If at 708 the system determines that access is not authorized, then process 700 continues to 706, wherein the system maintains locking of the one or more enclosures. However, if at 708 the system determines that access is authorized for the identity, then process 700 continues to 710, wherein the system unlocks the one or more enclosures (e.g., via control component 140 and one or more enclosure locking systems 126).

At 712, the system further determines (e.g., via authorization component 128) usage authorization information regarding whether and how the person is authorized to utilize one or more operating functionalities of the vehicle based on the verification of the identity of the person and reference usage authorization information (e.g., reference usage authorization information 148) defining usage permissions for the one or more defined identities. At 714, the system further controls (e.g., via control component 140 and one or more of the corresponding vehicle systems, such as but not limited to, driving system 128, HVAC system 130, and/or one or more other vehicle system 132), usage of the one or more operating functionalities of the vehicle by the person in accordance with the usage authorization information.

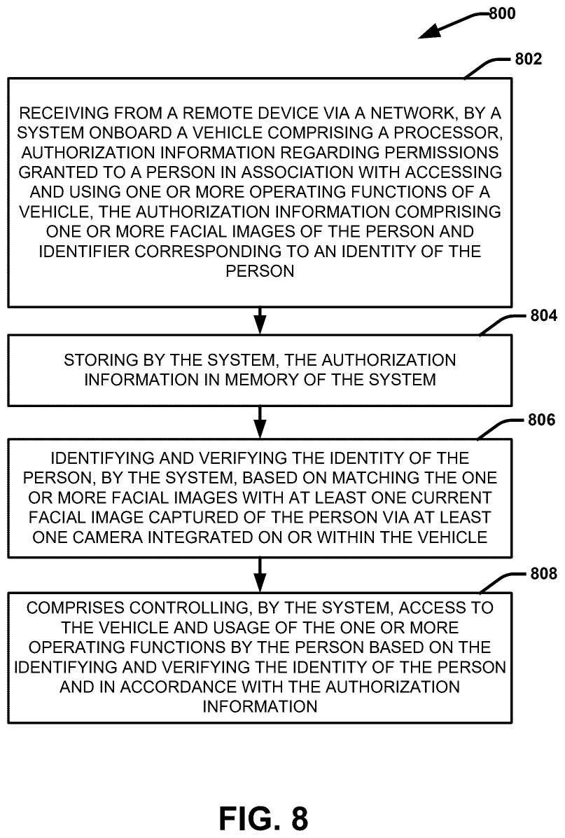

FIG. 8 illustrates a block flow diagram of an example, non-limiting computer-implemented method 800 for controlling vehicle access and usage functionality, in accordance with one or more embodiments described herein. Method 800 comprises, at 802, receiving from a remote device via a network (e.g., a remote device of one or more external systems/devices 120), by a system onboard a vehicle comprising a processor (e.g., onboard computer system 106), authorization information regarding permissions granted to a person in association with accessing and using one or more operating functions of a vehicle, the authorization information comprising one or more facial images of the person and identifier corresponding to an identity of the person. At 804, method 800 comprises storying by the system, the authorization information in memory of the system. At 806, method 800 comprises, identifying and verifying the identity of the person, by the system, based on matching the one or more facial images with at least one current facial image captured of the person via at least one camera integrated on or within the vehicle (e.g., via identification/verification component 136). At 808, method 800 further comprises controlling, by the system, access to the vehicle and usage of the one or more operating functions by the person based on the identifying and verifying the identity of the person and in accordance with the authorization information (e.g., via control component 140).

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 110 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors, field-programmable gate array, AI accelerator application-specific integrated circuit, or other suitable processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data. It is noted that unified Extensible Firmware Interface(s) can be utilized herein.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a disc 922 such as a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the. NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can be also connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are example and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

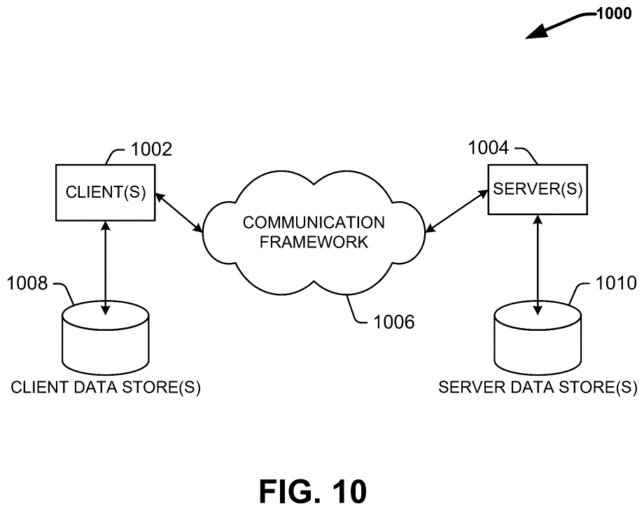

Referring now to FIG. 10, there is illustrated a schematic block diagram of a computing environment 1000 in accordance with this specification. The system 1000 includes one or more client(s) 1002, (e.g., computers, smart phones, tablets, cameras, PDA's). The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware or hardware in combination with software (e.g., threads, processes, computing devices). The servers 1004 can house threads to perform transformations of media items by employing aspects of this disclosure, for example. One possible communication between a client 1002 and a server 1004 can be in the form of a data packet adapted to be transmitted between two or more computer processes wherein data packets may include coded analyzed headspaces and/or input. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004. Further, the client(s) 1002 can be operatively connected to one or more server data store(s) 1010.

In one exemplary implementation, a client 1002 can transfer an encoded file, (e.g., encoded media item), to server 1004. Server 1004 can store the file, decode the file, or transmit the file to another client 1002. It is noted that a client 1002 can also transfer uncompressed file to a server 1004 and server 1004 can compress the file and/or transform the file in accordance with this disclosure. Likewise, server 1004 can encode information and transmit the information via communication framework 1006 to one or more clients 1002.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:
1. A system, comprising:
one or more sensors integrated on or within a vehicle;
a memory that stores computer executable components; and
a processor that executes the computer executable components stored in the memory, wherein the computer executable components comprise:
   an identification/verification component that performs an entity identification/verification process to identify and verify an identity of a person located within a defined distance relative to the vehicle based on biometric data captured of the person via at least one sensor of the one or more sensors and reference identity verification data for one or more defined identities;
   an authorization component that determines access authorization information regarding whether the person is authorized to access one or more internal compartments of the vehicle based on verification of the identity of the person in accordance with the entity identification/verification process and reference access authorization information defining access permissions for the one or more defined identities; and
   a control component that controls access to the one or more internal compartments via electronically controlling unlocking and locking of an enclosure of the one or more internal compartments in accordance with the access authorization information.
2. The system of clause 1, wherein the biometric data comprises facial image data of the person and wherein the identification/verification process comprises a facial recognition process.
3. The system of clause 2, wherein the memory and processor are integrated on or within the vehicle and wherein the facial recognition process comprises comparing the facial image data to reference facial image data for the one or more defined identities stored in the memory or another memory accessible to the identification/verification component via one or more wired or wireless communication networks.
4. The system of clause 1, wherein the biometric data comprises a combination of two or more different types of data selected from the group consisting of: facial image data, body image data, voice data, fingerprint data, iris/retina data and gesture data.
5. The system of clause 1, wherein the entity identification/verification process comprises a defined sequence of two or more different identity verification checks.
6. The system of clause 1, wherein the identification/verification component initiates performance of the entity identification/verification process to identify and verify the identity of the person based on detection of the person within the defined distance relative to the vehicle or detection of contact between the person and an external surface of a body of the vehicle.
7. The system of clause 1, wherein the computer-executable components further comprise: an artificial intelligence component that learns the reference access authorization information based on tracked biometric data captured of respective persons corresponding to the one or more defined identities captured via the one or more sensors and using one or more machine learning techniques.
8. The system of clause 1, wherein the one or more internal compartments comprise a main cabin compartment and a trunk compartment, wherein the one or more defined identities comprise different identities, and wherein the access authorization information varies the access permissions with respect to the main compartment and the trunk for the different identities.
9. The system of cause 1, wherein the authorization component further determines usage authorization information regarding whether and how the person is authorized to utilize one or more operating functionalities of the vehicle based on the verification of the identity of the person and reference usage authorization information defining usage permissions for the one or more defined identities, and wherein the control component controls usage of the one or more operating functionalities of the vehicle by the person in accordance with the usage authorization information.
10. The system of clause 9, wherein the one or more operating functionalities comprise a driving functionality, and wherein the control component controls activation and deactivation of the driving functionality in accordance with the usage authorization information.
11. The system of clause 10, wherein the usage authorization information further controls usage of the driving functionality with respect to speed, location, route, duration, and other contextual parameters.
12. The system of clause 9, wherein the one or more defined identities comprise different identities and wherein the usage authorization information varies for the different identities.
13. The system of clause 9, wherein the computer-executable components further comprise: an artificial intelligence component that learns the reference usage authorization information based on tracked usage data regarding historical usage of the one or more operating functionalities of the vehicle by the one or more defined identities and using one or more machine learning techniques.
14. The system of clause 9, wherein the computer-executable components further comprise: a security programming component that enables one or more authorized entities to define and program, via one or more electronic input devices coupled to the system, the identity verification process as tailored to the one or more defined identities, the reference identity verification data, the reference access authorization information, and the reference usage authorization information.

The system of clause 1 above with any set of combinations of the vehicles of clauses 2-14 above.
15. A method, comprising:
performing, by a system onboard a vehicle and comprising a processor, an entity identification/verification process to identify and verify an identity of a person located within a defined distance relative to the vehicle based on biometric data captured of the person, via one or more sensors located on or within the vehicle, and reference identity verification data for one or more defined identities;
determining, by the system, access authorization information regarding whether the person is authorized to access one or more internal compartments of the vehicle based on verification of the identity of the person in accordance with the entity identification/verification process and reference access authorization information defining access permissions for the one or more defined identities; and
controlling, by the system, access to the one or more internal compartments via electronically controlling unlocking and locking of an enclosure of the one or more internal compartments in accordance with the access authorization information.
16. The method of clause 15, wherein the biometric data comprises facial image data of the person and wherein the identification/verification process comprises a facial recognition process.
17. The method of clause 15, wherein the one or more internal compartments comprise a main cabin compartment and a trunk compartment, wherein the one or more defined identities comprise different identities, and wherein the access authorization information varies the access permissions with respect to the main compartment and the trunk for the different identities.
18. The method of clause 15, further comprising: determining, by the system, usage authorization information regarding whether and how the person is authorized to utilize one or more operating functionalities of the vehicle based on the verification of the identity of the person and reference usage authorization information defining usage permissions for the one or more defined identities; and controlling, by the system, usage of the one or more operating functionalities of the vehicle by the person in accordance with the usage authorization information.
19. The method of clause 18, wherein the one or more defined identities comprise different identities and wherein the usage authorization information varies for the different identities.

The method of clause 15 above with any set of combinations of the methods of clauses 16-19 above.
20. A non-transitory machine-readable storage medium, comprising executable instructions that, when executed by a processor integrated on or within a vehicle, facilitate performance of operations, comprising: performing an entity identification/verification process to identify and verify an identity of a person located within a defined distance relative to the vehicle based on biometric data captured of the person, via one or more sensors located on or within the vehicle, and reference identity verification data for one or more defined identities;

determining access authorization information regarding whether the person is authorized to access one or more internal compartments of the vehicle based on verification of the identity of the person in accordance with the entity identification/verification process and reference access authorization information defining access permissions for the one or more defined identities; and controlling access to the one or more internal compartments via electronically controlling unlocking and locking of an enclosure of the one or more internal compartments in accordance with the access authorization information.

What is claimed is:

1. A system, comprising:
one or more sensors integrated on or within a vehicle;
a memory that stores computer executable components; and
a processor that executes the computer executable components stored in the memory, wherein the computer executable components comprise:
an identification/verification component that performs an entity identification/verification process to identify and verify an identity of a person located within a defined distance relative to the vehicle based on biometric data captured of the person via at least one sensor of the one or more sensors and reference identity verification data for one or more defined identities;
an authorization component that determines access authorization information regarding whether the person is authorized to access one or more internal compartments of the vehicle based on verification of the identity of the person in accordance with the entity identification/verification process and reference access authorization information defining access permissions for the one or more defined identities; and
a control component that controls access to the one or more internal compartments via electronically controlling unlocking and locking of an enclosure of the one or more internal compartments in accordance with the access authorization information.

2. The system of claim 1, wherein the biometric data comprises facial image data of the person and wherein the identification/verification process comprises a facial recognition process.

3. The system of claim 2, wherein the memory and processor are integrated on or within the vehicle and wherein the facial recognition process comprises comparing the facial image data to reference facial image data for the one or more defined identities stored in the memory or another memory accessible to the identification/verification component via one or more wired or wireless communication networks.

4. The system of claim 1, wherein the biometric data comprises a combination of two or more different types of data selected from the group consisting of: facial image data, body image data, voice data, fingerprint data, iris/retina data and gesture data.

5. The system of claim 1, wherein the entity identification/verification process comprises a defined sequence of two or more different identity verification checks.

6. The system of claim 1, wherein the identification/verification component initiates performance of the entity identification/verification process to identify and verify the identity of the person based on detection of the person within the defined distance relative to the vehicle or detection of contact between the person and an external surface of a body of the vehicle.

7. The system of claim 1, wherein the computer-executable components further comprise:
an artificial intelligence component that learns the reference access authorization information based on tracked biometric data captured of respective persons corresponding to the one or more defined identities captured via the one or more sensors and using one or more machine learning techniques.

8. The system of claim 1, wherein the one or more internal compartments comprise a main cabin compartment and a trunk compartment, wherein the one or more defined identities comprise different identities, and wherein the access authorization information varies the access permissions with respect to the main compartment and the trunk for the different identities.

9. The system of claim 1, wherein the authorization component further determines usage authorization information regarding whether and how the person is authorized to utilize one or more operating functionalities of the vehicle based on the verification of the identity of the person and reference usage authorization information defining usage permissions for the one or more defined identities, and
wherein the control component controls usage of the one or more operating functionalities of the vehicle by the person in accordance with the usage authorization information.

10. The system of claim 9, wherein the one or more operating functionalities comprise a driving functionality, and wherein the control component controls activation and deactivation of the driving functionality in accordance with the usage authorization information.

11. The system of claim 9, wherein the usage authorization information further controls usage of the driving functionality with respect to speed, location, route, duration, and other contextual parameters.

12. The system of claim 9, wherein the one or more defined identities comprise different identities and wherein the usage authorization information varies for the different identities.

13. The system of claim 9, wherein the computer-executable components further comprise:
an artificial intelligence component that learns the reference usage authorization information based on tracked usage data regarding historical usage of the one or more operating functionalities of the vehicle by the one or more defined identities and using one or more machine learning techniques.

14. The system of claim 9, wherein the computer-executable components further comprise:
a security programming component that enables one or more authorized entities to define and program, via one or more electronic input devices coupled to the system, the identity verification process as tailored to the one or more defined identities, the reference identity verification data, the reference access authorization information, and the reference usage authorization information.

15. A method, comprising:
performing, by a system onboard a vehicle and comprising a processor, an entity identification/verification process to identify and verify an identity of a person located within a defined distance relative to the vehicle based on biometric data captured of the person, via one or more sensors located on or within the vehicle, and reference identity verification data for one or more defined identities;
determining, by the system, access authorization information regarding whether the person is authorized to access one or more internal compartments of the vehicle based on verification of the identity of the person in accordance with the entity identification/verification process and reference access authorization information defining access permissions for the one or more defined identities; and
controlling, by the system, access to the one or more internal compartments via electronically controlling unlocking and locking of an enclosure of the one or more internal compartments in accordance with the access authorization information.

16. The method of claim 15, wherein the biometric data comprises facial image data of the person and wherein the identification/verification process comprises a facial recognition process.

17. The method of claim 15, wherein the one or more internal compartments comprise a main cabin compartment and a trunk compartment, wherein the one or more defined identities comprise different identities, and wherein the access authorization information varies the access permissions with respect to the main compartment and the trunk for the different identities.

18. The method of claim 15, further comprising:
determining, by the system, usage authorization information regarding whether and how the person is authorized to utilize one or more operating functionalities of the vehicle based on the verification of the identity of the person and reference usage authorization information defining usage permissions for the one or more defined identities; and
controlling, by the system, usage of the one or more operating functionalities of the vehicle by the person in accordance with the usage authorization information.

19. The method of claim 18, wherein the one or more defined identities comprise different identities and wherein the usage authorization information varies for the different identities.

20. A non-transitory machine-readable storage medium, comprising executable instructions that, when executed by a processor integrated on or within a vehicle, facilitate performance of operations, comprising:
performing an entity identification/verification process to identify and verify an identity of a person located within a defined distance relative to the vehicle based on biometric data captured of the person, via one or more sensors located on or within the vehicle, and reference identity verification data for one or more defined identities;
determining access authorization information regarding whether the person is authorized to access one or more internal compartments of the vehicle based on verification of the identity of the person in accordance with the entity identification/verification process and reference access authorization information defining access permissions for the one or more defined identities; and
controlling access to the one or more internal compartments via electronically controlling unlocking and locking of an enclosure of the one or more internal compartments in accordance with the access authorization information.
